(19) United States
(12) Patent Application Publication
(10) Pub. No.: US 2008/0035503 A1
(43) Pub. Date: Feb. 14, 2008

(54) OPTICAL DISC CARRYING CASE WITH ACTIVATION WINDOW

(76) Inventors: Peter M. Rentzepis, Irvine, CA (US); Richard H. Selinfreund, Terre Haute, IN (US); Craig Etchegoyen, Newport Beach, CA (US); Alexander Dvornikov, Irvine, CA (US)

Correspondence Address: KELLEY DRYE & WARREN LLP, 400 ALTLANTIC STREET , 13TH FLOOR, STAMFORD, CT, 06901, US

(21) Appl. No.: 11/768,753

(22) Filed: Jun. 26, 2007

Related U.S. Application Data
(60) Provisional application No. 60/805,976, filed on Jun. 27, 2006.

(51) Int. Cl. G11B 33/04

(52) U.S. Cl. 206/308.1

(57) ABSTRACT

A storage case of storing optical digital data storage media, the case including a cover with a defined area therein that permits transmission of certain energy to the medium stored therein while the area of the cover outside of the defined area does not.

### CROSS-REFERENCE TO RELATED APPLICATIONS

This application claims benefit of U.S. Provisional Patent Application Ser. No. 60/805,976, filed Jun. 27, 2006. The disclosure of the application is hereby incorporated by reference in its entirety where appropriate for teachings of additional or alternative details, features, and/or technical background, and from which priority is asserted.

### BACKGROUND OF THE INVENTION

1. Field of the Invention

The present invention generally relates to a carrying case which permits activation of an optical recording medium situated therein without need for opening the case.

2. Description of the Related Art

The development of many types of transportable optical digital storage media which contain stored digital data readable by an optical reader has burgeoned over the past thirty years. Such optical digital storage media include such well known items as compact discs, digital video discs, blue-ray discs, and optical digital memory cards. Such storage media may be passive (such as a typical CD disc) or active, such as a digital memory card containing a processor.

As data stored on such transportable digital storage media may be valuable in its own right, there has been substantial resources applied to illicitly obtaining such data from authorized digital storage media and recording such data on non-authorized digital storage media. Unfortunately, with most traditional transportable digital recording media, extraction of the data from the transportable storage media is possible anywhere in its distribution chain or at any point in which it is read. The extraction of data from such media may result in the loss of a potential sale of one or more copies of the authorized media.

As described in applicant's prior applications, optical media can be protected against piracy of data and illicit copying by application of optical state change materials to the disc in a manner to alter read of data recorded on the media when the optical state change material is in one of two or more states. Without limitation, the alteration of read may involve a change in the optical state change material form a state blocking read of data to a state allowing read of data, may entail a software and/or hardware block of read of part or all of the content on the disc unless an optical state change is discerned in or on the optical medium in a pre-determined manner encoded in the software, may entail a transient or non-transient optical change that alters the data read of the underlying data on the optical medium in whole or in part, and/or may involve computer locking software which locks the medium to a computer system upon which it is read and requires a particular optical state change material to be placed on or in the medium in a specified manner for read on such computer system.

Applicant has described previously systems and methods for protecting against piracy in the distribution chain. In one of such embodiments, the optical recording medium has associated therewith a state change material, which may be an optical state change material, which blocks read of data by an optical reader when the material is in one state (e.g., optical state), but allows read by an optical reader of such data when the state change material is in another state (e.g., a second optical state). In another embodiment, the optical state change material must be in a particular state in order for software associated with the optical recording medium, or with the hardware on which it is read and deciphered to allow the optical recording medium to be read. In such embodiments, the read of the optical recording medium is impaired, in whole or in part, until the optical state change material is altered.

Optical recording medium, in particular optical discs, are conventionally stored in a case to protect against environmental contamination of the medium and to guard against degradation of the disc due to environmental conditions (e.g., due to high heat). Optical disc cases typically comprise a top cover and a bottom cover adjoined together. The bottom cover often includes comprise a disc holder configured to engage an optical disc at its central hole. The disc holder may comprise a boss at the central area of the bottom cover, the boss often comprising a plurality of resilient lips that extend radially, and bend upward to form a snap portion that has a curved shape on which is provided a claw. To store an optical disc in a case, the user places the central hole of the optical disc in alignment on the boss and presses down the optical disc to snap fit the claw with the central hole of the optical disc. The stored disc is then protected from the environment by closing the top cover and locking it to the bottom cover through interlocking members on each cover. When the optical disc has to be taken out, the user unlocks the top and bottom cover, presses on a pressing portion on the inside bottom cover to incline and disengage the claw from the central hole of the optical disc and removes the disc from the case.

Cases for storage of optical recording medium are often designed to be either completely opaque with respect to each of the top and bottom cover or clear with respect to the cover facing the label side of the disc (such that the disc label may be read). With respect to the piracy-protection of optical recording medium in the distribution chain as discussed above, conventional storage cases for optical recording medium suffer from a number of draw backs. With respect to opaque storage cases, the optical medium may be needed to be removed from the case before the state change material can be activated to a state allowing for read of the medium, or portion thereof. With respect to storage cases that are clear on both or one of the top and bottom cover, impingement of environmental light may lead to degradation of the state change material or an unintended a change in its optical state. Further, activating wavelengths necessary for converting the state change material used to block read, may also effect state change materials which are to used for copy-protection methods, authentication by software, etc. as described in the applicant's prior applications.

There is therefore a need for an improved optical recording medium storage case which allows for selective activation of state change material desired to be activated in order to allow read, or more robust read, or full read, of the piracy-protected optical recording medium.

### DEFINITIONS

Digital Datum Indicia: an indicium or indicia on a Digital Recording Medium corresponding to a digital data read. Such indicia include optical pits and lands on an optical recording medium, electromagnetically altered portions on a floppy drive, recording dyes altered for digital read, punctuate indicia representative of a data read.

Digital Reader: any device capable of detecting and reading digital information that has been recorded on an Digital Recording Medium. By the term “reader” it is meant to include, without limitation, a player. Examples are CD and DVD readers.

Digital Recording Medium: a medium of any geometric shape (not necessarily circular) that is capable of storing information in digital form thereon. Digital recording medium includes, without limitation, CD, DVDs, HD-DVDs, electromagnetic tape and disks, flash drives and Optical Medium. Information stored on the medium may include, without limitation, software programs, software data, audio files and video files.

Digitizing: Conversion of non-textual data to digital form.

Encoding: Recording electronic information.

Encryption: Transferring information based on a key to make it intelligible to unauthorized parties.

Optical State-Change Material: is a State-Change Material that alters a measurable state (e.g., without limitation, opacity, absorbance, reflectivity and/or color) upon application of a wavelength, or subwavelength, of light or application of photonic energy to the material.

Optical Medium: a medium of any geometric shape (not necessarily circular) that is capable of storing indicia or content that may be read by an optical reader.

Optical Reader: a Reader (as defined below) for the reading of Optical Medium.

Permanent State-Change Material: a State-Change Material that once activated to change a measurable state upon application of energy to the material, stays in such state permanently or for a prolonged period of time.

State-Change Material: a material capable of altering a measurable property of the material upon activation of the material by application of energy to the material. By “state change material” it is meant to include, without limitation, materials that change in optical state upon application of energy to the materials, materials that change in electromagnetic state (e.g., electroconductive state) upon application of energy to the materials, and materials that change in physical state (e.g. crystalline to non-crystalline structure) upon application of energy to the material.

Temporary State-Change Material: a State-Change Material that, once activated to change a measurable property of the material upon application of energy to the material, stays in such state for a period of time less than a year.

Transient State-Change Material: a State-Change material that, once activated to change a measurable property of the material, spontaneously in a short period of time (minutes or less), loses such change in the measurable property. It includes, without limitation, materials that move from a first state to a second state upon application of energy, and back to the first state without application of energy.

Transportable Digital Recording Medium: a relatively small medium capable of being transported by hand from one location to another that includes data readable in a digital manner. It includes, without limitation, an optical disc, a floppy disk, a flash drive.

For the purpose of the rest of the disclosure, it is understood that the terms as defined above are intended, whether such terms are in all initial cap or not.

### SUMMARY OF THE INVENTION

Embodiment disclosed herein include:

An optical recording medium storage case for storing optical recording medi(a), the storage case comprising: a bottom cover including a bottom board, a front peripheral projection, a rear peripheral projection, a left peripheral projection and a right peripheral projection; and a top cover including a top board, a left peripheral segment, a front peripheral segment and a rear peripheral segment, the top cover operatively affixed along its rear peripheral segment to the rear peripheral projection of the bottom cover to allow the same to pivot with respect to the bottom cover, and the top cover including a defined area within the top board which is comprised of a material having distinctly different wavelength transmissibility characteristics than the material comprising the bulk of the remainder of the top board. The defined area may comprise a translucent polymeric material, such as a polyethylene or polyurethane. The transmissibility of the defined area may be selected to provide for the transmission of a wavelength of light (or energy pulse/transmission etc.) that allows for conversion of state of state change material which underlies the defined area and which is desired to be converted to open read of the optical digital recording medium when it is read on an optical reader. For example, if the optical state change material selected to inhibit read of the optical medium changes state at a wavelength from about 250 nm to about 300 nm (the new state allowing read or fuller read of the optical disc), the transmissibility of the material comprising the defined area should permit transmission of a wavelength of about 250 nm to about 300 nm. Further, if other optical state change materials are incorporated onto the optical medium commensurate with the defined area in the top board, and such materials are not desired to be activated to another state, the other optical state change materials selected advantageously would not convert within the same wavelength range as the optical state change material which is desired to be converted. In one embodiment, the defined area permits transmission of a wavelength of between about 250 nm to about 300 nm to an optical digital data recording medium stored in the case whereas the remainder material of the top board does not.

A further embodiment disclosed is an optical disc storage case assembly comprising:

an optical disc having an optical state change material in or on the lead-in area of the optical disc; and

a storage case comprising:
a bottom cover including a bottom board, a front peripheral projection, a rear peripheral projection, a left peripheral projection and a right peripheral projection and an extending region configured to retain the optical disc on the bottom cover,
a top cover including a top board, a left peripheral segment, a front peripheral segment and a rear peripheral segment, the top cover operatively affixed along its rear peripheral segment to the rear peripheral projection of the bottom cover to allow the same to pivot with respect to the bottom cover, and the top cover including a defined area within the top board extending about the lead-in area of the optical disc when the disc is retained on the bottom cover, the defined area comprised of a material having a wavelength transmissibility characteristic that permits a wavelength of light capable of activating the state change material in the lead-in area on the optical disc to pass through the material while the material than the material comprising the bulk of the remainder of the top board does not.

### BRIEF DESCRIPTION OF THE DRAWINGS

The drawings included herein provide further understanding of the invention. A brief introduction of the drawings follows:

FIG. 1 is a perspective view of a closed digital recording medium case structure.

### DETAILED DESCRIPTION OF THE INVENTION

In an embodiment there is disclosed a storage case for storing digital recording media, the case including a cover with a defined area therein that permits transmission of certain energy to the medium stored therein while the area of the cover outside of the defined area does not.

The digital recording medium may be a transportable digital recording medium, and in particular an optical medium. The digital recording medium may be of the type that encodes electronic data in digital datum indicia which is readable by a digital reader. Stored digital data may be in encrypted form. Digital data may be incorporated onto the medium by the process of digitizing information. The state change material may be a permanent state-change material, a temporary state change material or a transient state-change material.

In an embodiment, the digital recording media includes a state change material, such as an optical state change material, which is positioned with respect to information stored therein in a manner that when the state change material is in a first state, read of the information by a digital reader is hampered, while when the state change material is in a second state, read of the information is no longer hampered correspondingly. The state change material, for example, may be associated with digital datum indicia on an optical medium in a manner so as to block the read by an optical reader of the digital datum indicia, or to cause read errors due to the partial block of read of one or more indicium. A storage case designed to hold such optical media may include a defined area in one or both of the covers comprising the storage case that permits an energy transmission there through which corresponds or contains an energy transmission which is sufficient to cause a state change in the state change material such that read of the optical media is permitted.

Digital recording media, such as optical media, comprising state change material which is to be activated at a point in the distribution chain, for example at sell to a consumer, to permit read, fuller read, or full read of the optical media after activation, may be advantageously stored in the storage cases of the present embodiments. By locating a transmissibility area within an otherwise non-transmissionable (at least with respect to the activating transmission which activates the state change material in a manner to allow improved read of the optical media) cover in a manner such that such transmissibility area corresponds to the area of the digital recording media containing the state change material which is desired to be converted, one can effectuate an assembly that can easily and quickly be changed from a non-readable or limited read digital recording medium to a fully-readable or more fully-readable digital recording medium.

In one embodiment, the source for the activating energy is a xenon flash lamp producing a wavelength of between about 250 nm to about 300 nm. Such lamp may comprise a sealed tube, which maybe made of fused quartz, which is filled with a mixture of gases, primarily xenon, the electrodes carry electrical current to the gas mixture. The high voltage required to run such lamp may be stored on a capacitor. The flash that is produced by such lamp is initiated by first ionizing the gas mixture, then sending a large pulse current through the ionized gas. When the current pulse travels through the tube, it excites electrons surrounding the xenon atoms causing them to jump to higher energy levels. When the atom's electrons drop immediately back to a lower orbit, photons are produced. Xenon flash lamps may emit light in various spectral lines. As the duration of the flash emitted by a xenon flash tube can be accurately controlled, and a high intensity energy can be produced, such lamps may be effectively used to quickly and accurately activate state change materials of appropriate wavelength activations. Of course, the source of activation may be any source which produces the correct activation energy necessary for activating the state change material on the digital recording media to a state that allows for read of the media (or fuller read). The activation energy may be a light wavelength, in particular with regard to optical media, but may also be other energies such as sound waves, electromagnetic waves, electromagnetic pulses, moving elemental particles etc.

The defined area of transmissibility in one embodiment may comprise a hole which may or may not be covered with a transmissible material such as a translucent polymer. The defined area may also comprise in another embodiment a material of appropriate transmissibility integral with the other material of the cover through which a transmission is to be directed.

In one embodiment, the area of the digital recording medium which is associated with state change material in a manner to inhibit read of all or a portion of the digital recording medium, is the lead-in area of an optical recording medium, such as an optical disc. By blocking read of the lead-in area, read of the optical recording medium is inhibited. By appropriately designing the storage case for such media to have the transmissibility area of one or more of the covers directed over the lead-in area when the optical recording medium is stored in the storage case and the covers adjoined so as to close the case, one can easily activate the state change material, such as optical state change material, at the lead-in area of the optical medium without the need for removing the optical medium from the storage case before activation. That is, activation of the state change material may be by way of transmitting an activation wave, or energy transmission, through the transmissibility area to the optical medium.

Thus there is disclosed an optical recording medium storage case for storing optical recording medi(a), the storage case comprising:

a bottom cover including a bottom board, a front peripheral projection, a rear peripheral projection, a left peripheral projection and a right peripheral projection;

a top cover including a top board, a left peripheral segment, a front peripheral segment and a rear peripheral segment, the top cover operatively affixed along its rear peripheral segment to the rear peripheral projection of the bottom cover to allow the same to pivot with respect to the bottom cover, and the top cover including a defined area within the top board which is comprised of a material having distinctly different wavelength transmissibility characteristics than the material comprising the bulk of the remainder of the top board.

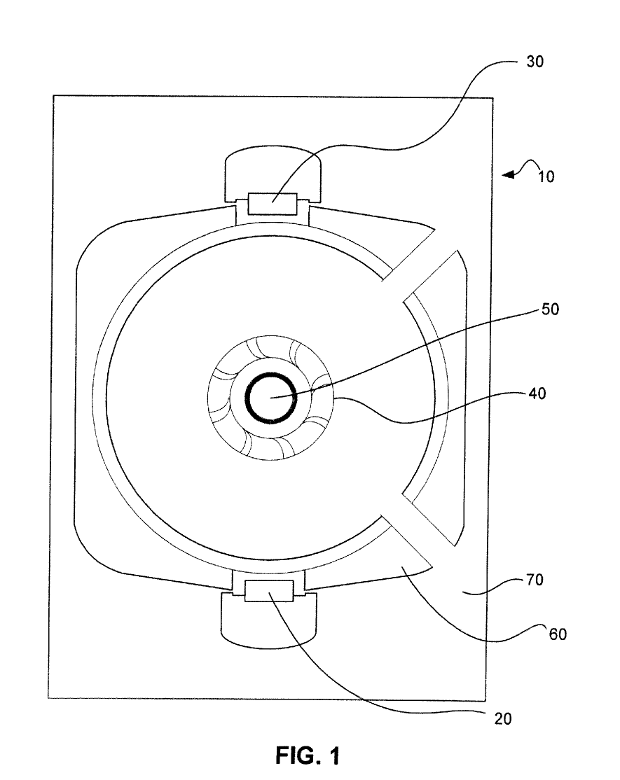

Turning to FIG. 1, there is shown one embodiment digital recording medium case 10. Case 10 comprises a bottom cover 70 and a top cover 60 which are fastened to one another. A digital recording media may be placed in case 10 by interacting with latches 20, 30 which allow top 60 to pivot about bottom cover 70 allowing a cavity in bottom cover 70 (not shown) to be accessed. Top cover 60 includes a transmissibility area 50 which may be demarcated for easy location by a structure 40 surround the same. Such transmissibility area permits transmissions to pass through top cover 60 to the digital recording medium stored within case 10.

### Statement Regarding Preferred Embodiments

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

1. An optical recording medium storage case for storing optical recording medi(a), said storage case comprising:
a bottom cover including a bottom board, a front peripheral projection, a rear peripheral projection, a left peripheral projection and a right peripheral projection;
a top cover including a top board, a left peripheral segment, a front peripheral segment and a rear peripheral segment, said top cover operatively affixed along its rear peripheral segment to said rear peripheral projection of said bottom cover to allow the same to pivot with respect to the bottom cover, and said top cover including a defined area within said top board which is comprised of a material having distinctly different wavelength transmissibility characteristics than the material comprising the bulk of the remainder of the top board.

2. A storage case as asserted in claim 1, wherein the defined area comprises a translucent polymeric material.

3. A storage case as asserted in claim 1, wherein the defined area permits transmission of a wavelength of between about 250 nm to about 300 nm to an optical digital data recording medium stored in the case whereas the remainder material of the top board does not.

4. A storage case as asserted in claim 2, wherein the polymeric material is polyethylene.

5. A storage case as asserted in claim 2, wherein the polymeric material is a polyurethane.

6. An optical disc storage case assembly comprising:
an optical disc having an optical state change material in or on the lead-in area of the optical disc, and
an storage case comprising:
a bottom cover including a bottom board, a front peripheral projection, a rear peripheral projection, a left peripheral projection and a right peripheral projection and an extending region configured to retain said optical disc on said bottom cover;
a top cover including a top board, a left peripheral segment, a front peripheral segment and a rear peripheral segment, said top cover operatively affixed along its rear peripheral segment to said rear peripheral projection of said bottom cover to allow the same to pivot with respect to the bottom cover, and said top cover including a defined area within said top board extending about the lead-in area of the optical disc when said disc is retained on said bottom cover, said defined area comprised of a material having a wavelength transmissibility characteristic that permits a wavelength of light capable of activating said state change material in said lead-in area on said optical disc to pass through the material while the material than the material comprising the bulk of the remainder of the top board does not.
